(19) United States
(12) Patent Application Publication
(10) Pub. No.: US 2022/0164000 A1
(43) Pub. Date: May 26, 2022

(54) EXPOSING BASE AND AUXILIARY PANELS OF DISPLAY DEVICE AS SEPARATE DISPLAYS OR AS ONE DISPLAY

(71) Applicant: Hewlett-Packard Development Company, L.P., Spring, TX (US)

(72) Inventors: Syed S. Azam, Spring, TX (US); Alexander Williams, Spring, TX (US)

(73) Assignee: Hewlett-Packard Development Company, L.P., Spring, TX (US)

(21) Appl. No.: 17/599,606

(22) PCT Filed: Jul. 26, 2019
(86) PCT No.: PCT/US2019/043712

§ 371 Date: Sep. 29, 2021

(51) Int. Cl. G06F 1/16

(52) U.S. Cl. CPC G06F 1/1649; G06F 1/1675; G06F 1/1616

(57) ABSTRACT

A display device includes a base panel and one or more auxiliary panels that are positionable between a hidden configuration behind the base panel and a visible configuration at a side of the base panel. The display device is communicatively connectable to a host computing device. Each auxiliary panel positioned in the visible configuration is exposed to the host computing device as part of one display along with the base panel or as a separate display, depending on the side of the base panel at which the auxiliary panel has been positioned and/or depending on the auxiliary panel that has been positioned.

### BACKGROUND

Computing devices such as desktop computers and portable computers like laptop and notebook computers are often connected to external display devices. For a computing device with an internal display, as is the case with laptop, notebook, and other types of portable computers as well as some types of desktop computers known as all-in-one (AIO) computers, using an external display can afford the user a larger display than the internal display, which may be used in addition to or in lieu of the internal display. For a computing device lacking an internal display, as is more typically the case with desktop computers, an external display is usually needed for the user to use the computer.

### BRIEF DESCRIPTION OF THE DRAWINGS

FIG. 1 is a top view diagram of an example display device having multiple display panels.

FIGS. 2A, 2B, 2C, 2D, 2E, and 2F are diagrams of examples of how a display device can expose its visible display panels to a host computing device.

FIGS. 3A and 3B are flowcharts of an example method for exposing display panels of a display device, based on the side of a base panel to which an auxiliary panel has been positioned.

FIG. 4 is a flowchart of another example method for exposing display panels of a display device, based on which auxiliary panel has been positioned besides a base panel.

FIG. 5 is a diagram of an example computer-readable data storage medium.

FIG. 6 is a flowchart of an example method.

FIG. 7 is a diagram of an example display device.

### DETAILED DESCRIPTION

As noted in the background, computing devices like computers are often connected to external display devices. An external display device may have one or more separate display panels. Each display panel may be a flat-panel display (FPD). The external display device may expose its display panels to the computing device to which it is connected as separate displays, or as one display.

Exposing the display panels as separate displays means that the host computing device sees each panel as a separate physical display, similar to as if multiple external display devices were each connected to the host computing device. Each display panel may have a native resolution. The external display device may thus expose each display panel as a separate display at the native resolution of the panel.

Exposing the display panels as one display means that the host computing device sees the panels as if they were one physical display, similar to as if an external display device having just one display panel was connected to the host computing device. The external display device may expose the display panels as one display at a native resolution spanning the native resolutions of the individual panels. For example, if the display panels are physically positionable side-by-side, each panel may have a native resolution with the same vertical height and with the same or different horizontal width. The external display device may expose the panels as one display at a native resolution having a vertical height of each panel and a horizontal width equal to the sum of the horizontal widths of the panels.

The display panels of an external display device may be positionable relative to one another. For example, a base panel may remain visible at all times, and one or more auxiliary panels may each be positionable from a hidden configuration behind the base panel to a visible configuration besides the base panel. A user can thus hide auxiliary panels behind the base panel when they are not needed or when physical space is at a premium, and position them in the visible configuration when more physical space is available and more display space is needed.

Techniques described herein control how a display device exposes its constituent display panels to a host computing device to which it is communicatively connected. The display device may expose the panels as separate displays or as one display based on the side of the base panel to which an auxiliary panel has been positioned. The display device may expose the panels as separate displays or as one display based on which auxiliary panel has been positioned from a hidden configuration to a visible configuration, regardless of the side of the base panel to which the auxiliary panel has been positioned. Auxiliary panels are thus be physically positioned, such as by a user, to sides of base panel, and how the host computing device “sees” these panels is controlled by how the display device exposes the visible panels (as one or more displays).

That a display device exposes one or more of its constituent panels as one or more displays to a host computing device to which the display device is connected means that the display device communicates to the computing device at least the number of displays and the supported resolution of each display, over a display interface interconnecting the display device to the computing device. For example, when a single-panel display device is connected to a computing device, the information communicated over the display interface can indicate that one display is connected (corresponding to the panel) and that the display has a native resolution equal to that of the panel. In the case when multiple single-panel display devices are daisy-chained to the computing device (i.e., the computing device is connected to a first display device, which is connected to a second display device, and so on), the information communicated over the display interface indicates that two display devices are connected, with native resolutions equal to that of their respective panels.

In the techniques described herein, a display device has multiple panels, but can differently expose them to a host computing device to which the display device is connected. That is, the display device communicates to the computing device a number of displays that may be different than the number of visible panels, with each display having a native resolution that may differ from the native resolution of any such panel. For example, three panels of a display device may be visible. The display device may indicate on the display interface that just one display is connected, however, at a native resolution spanning the native resolutions of all three panels. The display device may indicate on the display interface that two displays are connected, with one display having a native resolution spanning the native resolutions of two panels, and another display having a resolution equal to that of a third panel. The display device may indicate on the display interface that three displays are connected, with each display having a native resolution of a corresponding panel.

The techniques described herein permit users to easily reconfigure how the display panels of a display device are used without having to change any settings accessible via built-in controls and an on-screen display (OSD) of the device. Users can easily reconfigure how the display panels are used with a computing device without having to change any settings at the computing device itself. From the perspective of the computing device, such as the operating system running thereon, the computing device may not be aware that just one display device having multiple panels is connected, as opposed to multiple display devices, when the panels are exposed as separate displays. The computing device may not be aware that the display device has multiple panels, as opposed to just one panel, when the panels are exposed as one display. The display device may be considered as logically exposing its visible panels as one or more displays over the display interface connecting the display device to the computing device. The computing device may consider these displays as separate physical display devices, even though a display may correspond to more than one display panel.

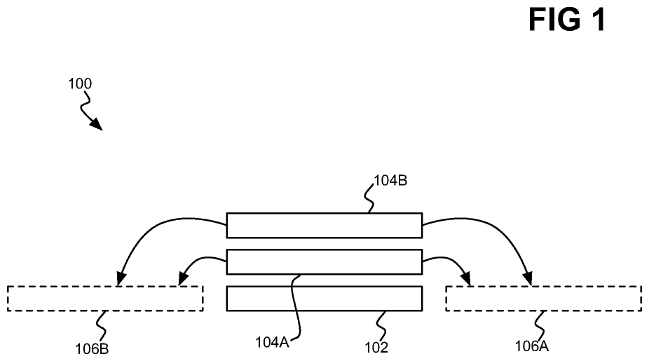

FIG. 1 shows a top view of an example display device 100. The display device 100 may be an external display device that is communicatively connected to a host computing device, like a desktop, laptop, or notebook computer, via one or more cables. Examples of such cables include HDMI, DisplayPort, and Thunderbolt cables, as well as other types of cables.

The display device 100 includes a base display panel 102 and auxiliary display panels 104A and 104B, which are collectively referred to as the auxiliary panels 104. While two auxiliary panels 104 are depicted in FIG. 1, there may be just one auxiliary panel 104, or more than two auxiliary panels 104. Each of the display panels 102 and 104 is a physically separate display panel, such as an FPD panel.

The auxiliary panels 104 are depicted in a hidden configuration. The hidden configuration of an auxiliary panel 104 can be defined as a position of the panel 104 within the display device 100 such that its display side (i.e., the side on which images are displayed) is blocked by another part of the device 100. For example, in FIG. 1, the auxiliary panels 14 are depicted behind the base panel 102. In the hidden configuration, the display side of an auxiliary panel 104 is not visible to a user situated in front of the base panel 102. When all the auxiliary panels 104 are positioned in the hidden configuration, the display device 100 exposes one display to the host computing device, corresponding to the base panel 102 that is visible to and usable by the user. For instance, the display device 100 may expose the base panel 102 as a display at a native resolution of the panel 102.

The auxiliary panels 104 are each physically positionable from the hidden configuration behind the base panel 102 to a visible configuration besides the base panel 102. In one implementation, each auxiliary panel 104 is positionable to either side of the base panel 102. For example, each auxiliary panel 104 is positionable to a position 106A to the right of the base panel 102 as well as to a position 1066 to the left of the base panel 102. The positions 106A and 106B are collectively referred to as the positions 106.

In another implementation, each auxiliary panel 104 may be positionable to just one side of the base panel 102. For example, the auxiliary panel 104A may be positionable to the position 106A to the right of the base panel 102 but not to the position 1066 to the left of the base panel 102. The auxiliary panel 1046 may be positionable to the position 1066 to the left of the base panel 102 but not to the position 106A to the right of the base panel 102.

The auxiliary panels 104 may be positionable from the hidden configuration behind the base panel 102 to a visible configuration besides the base panel 102 in a variety of different ways. For example, the auxiliary panels 104 may each slide along tracks or grooves from the hidden configuration behind the base panel 102 to a visible configuration to the left and/or the right of the base panel 102. As another example, the auxiliary panels 104 may be pivotably affixed to hinges or arms that permit each panel 104 to rotate up and over the base panel 102 from the hidden configuration behind the base panel 102 to a visible configuration to the left and/or the right of the base panel 102.

The auxiliary panels 104 can be individually positionable from the hidden configuration behind the base panel 102 to a visible configuration besides the base panel 102. For instance, the auxiliary panel 104A may be positioned in a visible configuration besides the base panel 102 while the auxiliary panel 104B remains in the hidden configuration behind the base panel 102. The auxiliary panel 104B may likewise be positioned in a visible configuration besides the base panel 102 while the auxiliary panel 104A remains in the hidden configuration behind the base panel 102. Both auxiliary panels 104 may remain in the hidden configuration behind the base panel 102, and both auxiliary panels 104 may be positioned in the visible configuration besides the base panel 102.

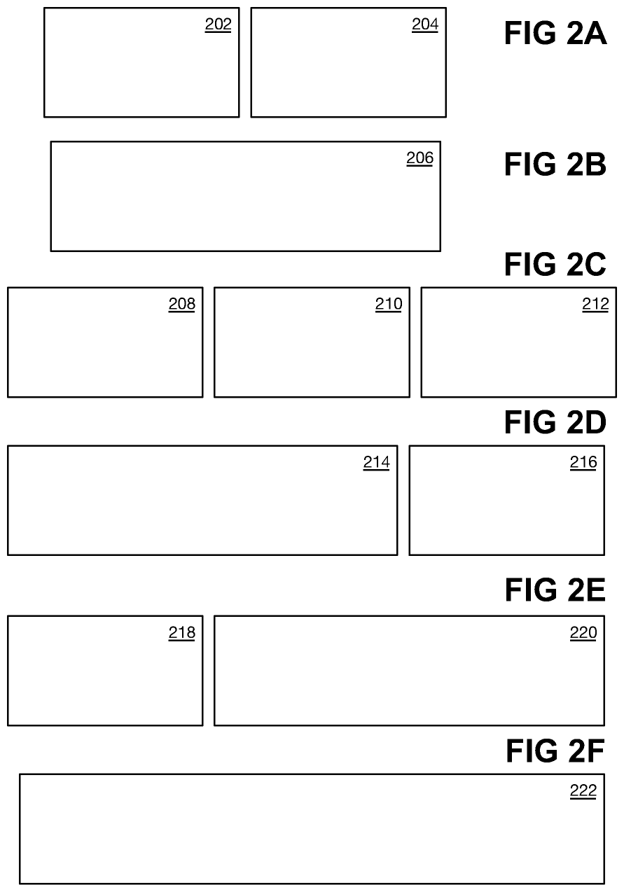

FIGS. 2A, 2B, 2C, 2D, 2E, and 2F show examples of how the display device 100 can expose the panels 102 and 104 to a host computing device when one or more of the auxiliary panels 104 have been positioned in a visible configuration besides the base panel 102. FIG. 2A corresponds to the scenario in which one auxiliary panel 104 has been positioned in a visible configuration besides the base panel 102 and in which the other auxiliary panel 104 remains in the hidden configuration behind the base panel 102. The display device 100 exposes two separate displays 202 and 204 to the host computing device.

If the auxiliary panel 104 in the visible configuration has been positioned to the right of the base panel 102, then the display device 100 exposes the base panel 102 as the display 202 and exposes the visible auxiliary panel 104 as the display 204. If the auxiliary panel 104 in the visible configuration has been positioned to the left of the base panel 102, then the display device 100 exposes the base panel 102 as the display 204 and exposes the visible auxiliary panel 104 as the display 202. The display device 100 can expose each of the displays 202 and 204 at the native resolution of the corresponding panel 102 or 104.

FIG. 2B also corresponds to the scenario in which one auxiliary panel 104 has been positioned in a visible configuration besides the base panel 102 and in which the other auxiliary panel 104 remains in the hidden configuration behind the base panel 102. The display device 100 exposes one display 206 to the host computing device, such as at a native resolution spanning the native resolutions of the base panel 102 and the visible auxiliary panel 104. For example, if the base panel 102 has a native resolution of X1×Y and the visible auxiliary panel 104 has a native resolution of X2×Y, then the display device 100 may expose one display 206 at a native resolution of (X1+X2)×Y.

FIG. 2C corresponds to the scenario in which both auxiliary panels 104 have been positioned in a visible configuration besides the base panel 104 such that neither auxiliary panel 104 remains in the hidden configuration behind the base panel 102. The display device 100 exposes three separate displays 208, 210, and 212. The display device 100 exposes the auxiliary panel 104 positioned to the left of the base panel 102 as a separate display 208, the base panel 102 as a separate display 210, and the auxiliary panel 104 positioned to the right of the base panel 102 as a separate display 212. The display device 100 can expose each of the displays 208, 210, and 212 at the native resolution of the corresponding panel 102 or 104.

FIG. 2D also corresponds to the scenario in which both auxiliary panels 104 have been positioned in a visible configuration besides the base panel 104 such that neither auxiliary panel 104 remains in the hidden configuration behind the base panel 102. The display devices 100 exposes two displays 214 and 216. The display device 100 exposes the auxiliary panel 104 to the left of the base panel 102 and the base panel 102 as one display 214, and exposes the auxiliary panel 104 to the right of the base panel 102 as a separate display 216. The display device 100 can expose the display 214 at a native resolution spanning the native resolutions of the left auxiliary panel 104 and the base panel 102, as in FIG. 2B, and can expose the display 216 at the native resolution of the right auxiliary panel 104.

FIG. 2E also corresponds to the scenario in which both auxiliary panels 104 have been positioned in a visible configuration besides the base panel 104 such that neither auxiliary panel 104 remains in the hidden configuration behind the base panel 102. The display device 100 exposes two displays 218 and 220. The display device 100 exposes the auxiliary panel 104 to the left of the base panel 102 as a separate display 218, and exposes the base panel 102 and the auxiliary panel 104 to the right of the base panel 102 as one display 220. The display device 100 can expose the display 218 at the native resolution of the left auxiliary panel 104, and can expose the display 220 at a native resolution spanning the native resolutions of the base panel 102 and the right auxiliary panel 104, as in FIG. 2B.

FIG. 2F also corresponds to the scenario in which both auxiliary panels 104 have been positioned in a visible configuration besides the base panel 102 such that neither auxiliary panel 104 remains in the hidden configuration behind the base panel 102. The display device exposes one display 222 to the host computing device, such as at a native resolution spanning the native resolutions of the base panel 102 and the auxiliary panels 104. For example, if the base panel 102 has a native resolution of X1×Y and each auxiliary panel 104 has a native resolution of X2×Y, then the display device 100 may expose one display 222 at a native resolution of (X1+(2×X2))×Y.

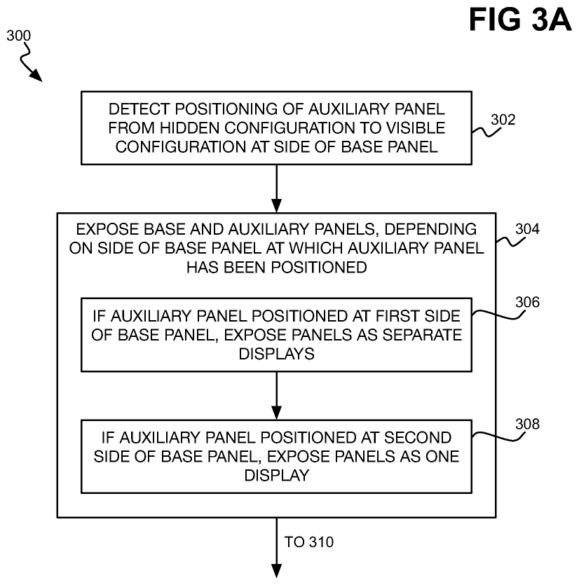

FIGS. 3A and 3B shows an example method 300 for exposing display panels of a display device to a host computing device, based on the side of a base panel to which an auxiliary panel has been positioned. The display device can perform the method 300. The method 300 can be implemented as program code stored on a non-transitory computer-readable data storage medium and executable by the display device. In the method 300, the display device includes at least one auxiliary panel in addition to a base panel.

Starting with all the auxiliary panels in the hidden configuration behind the base panel, the display device detects positioning of an auxiliary panel to a visible configuration at a side of the base panel (302). For instance, the display device may have a sensor for each auxiliary panel by which the device can detect whether the auxiliary panel is in the hidden configuration or in the visible configuration. The sensor for each auxiliary panel further permits the display device to detect the side of the base panel to which the auxiliary panel has been positioned when in the visible configuration.

The display device exposes the base panel and the auxiliary panel as separate displays or as one display depending on the side of the base panel to which the auxiliary panel has ben positioned (304). If the auxiliary panel has been positioned to a first side of the base panel, then the display device exposes the base and auxiliary panels as separate displays (306). If the auxiliary panel has been positioned to the second, opposite side of the base panel, then the display device exposes the base and auxiliary panels as one display (308). For example, if the auxiliary panel is positioned to the right of the base panel, then the display device may expose the panels as two separate displays, as in FIG. 2A; if the auxiliary panel is positioned to the left of the base panel, then the display device may expose the panels as one display, as in FIG. 2B.

The display device may include more than one auxiliary panel. The display device may thus detect positioning of another auxiliary panel from the hidden configuration behind the base panel to a visible configuration besides the base panel (310). In one implementation, the display device may expose this additional auxiliary panel in the same manner in which the prior auxiliary panel was exposed (312), whereas in another implementation, the display device may expose the additional auxiliary panel in a different manner to that in which the prior auxiliary panel was exposed (314).

In the former implementation (312), if the base and prior auxiliary panels were exposed as separate displays in part 304, then the display device exposes the additional auxiliary panel as another separate display (316), for a total of three exposed displays as in FIG. 2C. If the base and prior auxiliary panels were exposed as one display in part 304, then the display device exposes the additional auxiliary panel as part of this display along with the base panel and the prior auxiliary panel (318), as in FIG. 2F. The display that the display device exposes thus can increase in native resolution from FIG. 2B to FIG. 2F to also span the native resolution of the additional auxiliary panel.

In the latter implementation (314), if the base and prior auxiliary panels were exposed as separate displays in part 304, then the display device exposes the additional auxiliary panel as one display along with the base panel, with the prior auxiliary panel remaining exposed as a separate display (320). If the prior auxiliary panel is positioned to the right of the base panel and the additional auxiliary panel is positioned to the left of the base panel, then the display device now exposes two displays as in FIG. 2D. If the prior auxiliary panel is positioned to the left of the base panel and the additional auxiliary panel is positioned to the right of the base panel, then the display device now exposes two displays as in FIG. 2E.

By comparison, if the base and prior auxiliary panels were exposed as one display in part 304, then the display device exposes the additional auxiliary panel as a separate display (322). The exposure of the base and prior auxiliary panels as one display is unaffected. If the prior auxiliary panel is positioned to the right of the base panel and the additional auxiliary panel is positioned to the left of the base panel, then the display device now exposes two displays as in FIG. 2E. If the prior auxiliary panel is positioned to the left of the base panel and the additional auxiliary panel is positioned to the right of the base panel, then the display device now exposes two displays as in FIG. 2D.

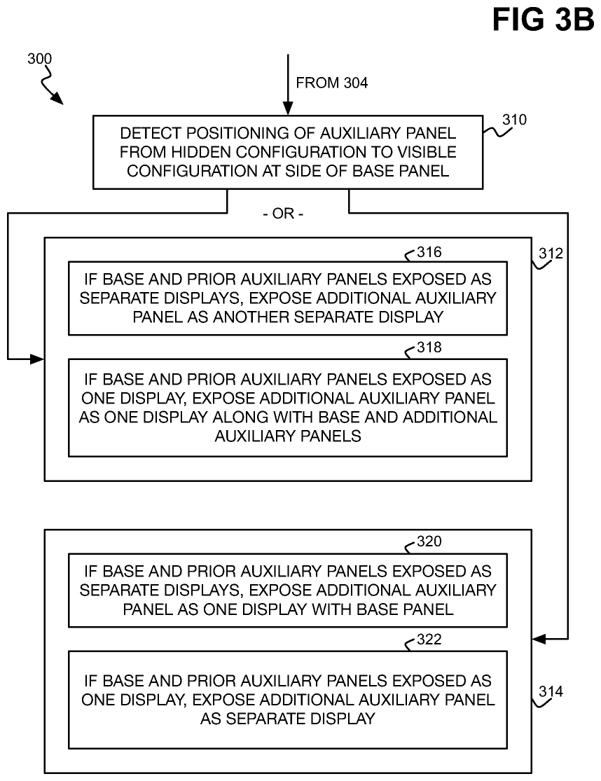

FIG. 4 shows an example method 400 for exposing display panels of a display device to a host computing device, based on which auxiliary panel has been positioned besides a base panel. The display device can perform the method 400. The method 400 can be implemented as program code stored on a non-transitory computer-readable data storage medium and executable by the display device. In the method 400, the display device includes more than one auxiliary panel in addition to the base panel.

Starting with all the auxiliary panels in the hidden configuration behind the base panel, the display device detects positioning of an auxiliary panel to a visible configuration at a side of the base panel (402). The auxiliary panel that has been positioned is referred to as the selected auxiliary panel. The display device exposes the base and selected auxiliary panels as separate displays or as one display, depending on which of the multiple auxiliary panels the selected auxiliary panel is (404), regardless of the side of the base panel to which the selected auxiliary panel has been positioned.

For example, the display device may include two auxiliary panels: a first auxiliary panel and a second auxiliary panel. If the auxiliary panel that has been positioned from the hidden configuration to a visible configuration in part 402 is the first auxiliary panel, then the base and first auxiliary panels may be exposed as separate displays in part 404, as in FIG. 2A, regardless of the side of the base panel to which the first auxiliary panel has been positioned. If the auxiliary panel that has been positioned from the hidden configuration to a visible configuration in part 402 is the second auxiliary panel, then the base and second auxiliary panels may be exposed as one display in part 404, as in FIG. 2B, regardless of the side of the base panel to which the second auxiliary panel has been positioned.

The display device may then detect positioning of another auxiliary panel from the hidden configuration behind the base panel to a visible configuration besides the base panel (406). This auxiliary panel is referred to as the additionally selected auxiliary panel. In one implementation, the display device may expose the additionally selected auxiliary panel in the same manner in which the previously selected auxiliary panel was exposed (408), whereas in another implementation, the display device may expose the additionally selected auxiliary panel in a different manner to that in which the previously selected auxiliary panel was exposed (410).

In the former implementation (408), if the base and previously selected auxiliary panels were exposed as separate displays in part 404, then the display device exposes the additionally selected auxiliary panel as another separate display (412), for a total of three exposed displays as in FIG. 2C. If the base and previously selected auxiliary panels were exposed as one display in part 404, then the display device exposes the additionally selected auxiliary panel as part of this display along with the base panel and the previously selected auxiliary panel (414), as in FIG. 2F. The display that the display device exposes thus can increase in native resolution from FIG. 2B to FIG. 2F to also span the native resolution of the additionally selected auxiliary panel.

In the latter implementation (410), if the base and previously selected auxiliary panels were exposed as separate displays in part 404, then the display device exposes the additionally selected auxiliary panel as one display along with the base panel (416). The previously selected auxiliary panel remains exposed as a separate display. The display device now exposes two displays as in FIG. 2D if the previously selected auxiliary panel is positioned to the right of the base panel, or as in FIG. 2E if the previously selected auxiliary panel is positioned to the left of the base panel.

By comparison, if the base and previously selected auxiliary panels were exposed as one display in part 404, then the display device exposes the additionally selected panel as a separate display (418). The exposure of the base and previously selected auxiliary panels as one display is unaffected. The display device now exposes two displays as in FIG. 2E if the previously selected auxiliary panel is positioned to the right of the base panel, or as in FIG. 2F if the previously selected auxiliary panel is positioned to the left of the base panel.

The methods 300 and 400 can each be extended to implementations in which there are more than two auxiliary panels in addition to a base panel in the display device. The methods 300 and 400 can also be combined. For instance, whether an auxiliary panel is displayed as a separate display or as part of a display along with at least the base panel may depend both on the auxiliary panel itself (i.e., on which auxiliary panel has been positioned from the hidden configuration to a visible configuration) and on the side of the base panel to which the auxiliary panel has been positioned. For example, one auxiliary panel may be displayed as a separate display if positioned to the left of the base panel, but as one display along with the base panel if positioned to the right of the base panel. Another auxiliary panel may be displayed as a separate display if positioned to the right of the base panel, but as one display along with the base panel if positioned to the left of the base panel.

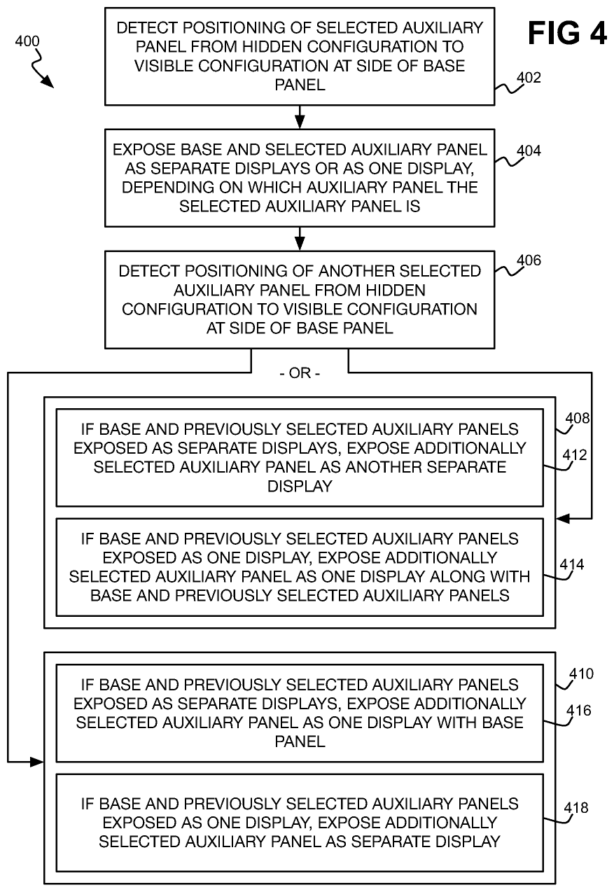

FIG. 5 shows an example non-transitory computer-readable data storage medium 500. The computer-readable data storage medium 500 stores program code 502 executable by a display device communicatively connectable to a host computing device to perform processing. The processing includes detecting positioning of an auxiliary panel of the display device from a hidden configuration behind a base panel of the display device to a visible configuration at a side of the base panel (504). The processing includes exposing the base panel and the auxiliary panel as separate displays to the host computing device or as one display to the host computing device, depending on the side of the base panel at which the auxiliary panel has been positioned (506).

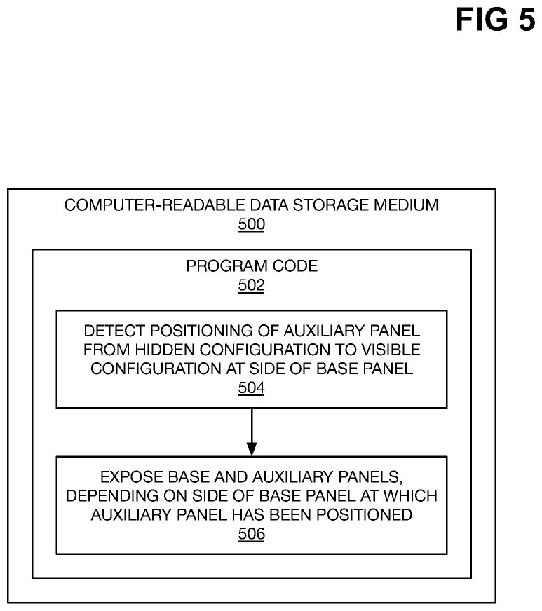

FIG. 6 shows an example method 600. The method 600 can be performed by a display device having a base panel and first and second auxiliary panels positioned in a hidden configuration behind the base panel. The display device is communicatively connectable to a host computing device. The method 600 includes detecting positioning of a selected auxiliary panel to a visible configuration at a side of the base panel (602). The method 600 includes exposing the base panel and the selected auxiliary panel as separate displays to the host computing device or as one display to the host computing device, depending on whether the selected auxiliary panel is the first auxiliary panel or the second auxiliary panel (604).

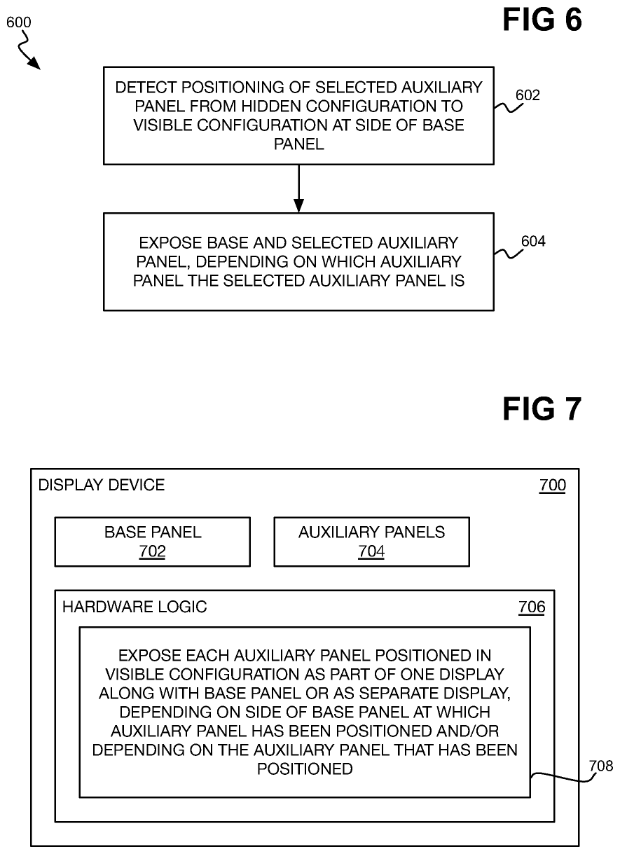

FIG. 7 shows an example display device 700. The display device 700 can be an external display device that can be communicatively connected to a host computing device. The display device 700 includes a base panel 702 and auxiliary panels 704. The auxiliary panels 704 are individually positionable between a hidden configuration behind the base panel 702 and a visible configuration at a side of the base panel 702.

The display device 700 includes hardware logic 706. The hardware logic 706 can include a non-transitory computer-readable data storage medium storing executable program code. The hardware logic 706 may include a general purpose or scalar processor that executes the code, for example, or as an accordingly programmed application-specific integrated circuit (ASIC). The hardware logic 706 is to expose to the host computing device each auxiliary panel 704 positioned in the visible configuration, either as part of one display along with the base panel 702 or as a separate display, depending on the side of the base panel 702 at which the auxiliary panel 704 has been positioned and/or depending on the auxiliary panel 704 that has been positioned (708).

Techniques have been described for exposing the display panels of a display device to a computing device to which the display device is connected. By controlling how the display panels are exposed based on the sides to which auxiliary panels have been positioned, and/or based on which auxiliary panels have been positioned, the techniques permit users to easily reconfigure how the panels are used. Users do not have to manually change settings corresponding to the desired configuration, within the display device itself or within the computing device.

We claim:

1. A non-transitory computer-readable data storage medium storing program code executable by a display device to perform processing comprising:
detecting positioning of an auxiliary panel of the display device from a hidden configuration behind a base panel of the display device to a visible configuration at a side of the base panel; and
exposing the base panel and the auxiliary panel as separate displays to a host computing device to which the display device is communicatively connected or as one display to the host computing device, depending on the side of the base panel at which the auxiliary panel is positioned.

2. The non-transitory computer-readable data storage medium of claim 1, wherein the base panel has a first side and a second side,
wherein responsive to the auxiliary panel being positioned at the first side of the base panel, the base panel and the second panel are exposed as the separate displays to the host computing device,
and wherein responsive to the auxiliary panel being positioned at the second side of the base panel, the base panel and the second panel are exposed as the one display to the host computing device.

3. The non-transitory computer-readable data storage medium of claim 1, wherein the auxiliary panel is a first auxiliary panel of the display device, and the processing further comprises:
detecting positioning of a second auxiliary panel of the display device from the hidden configuration behind the base panel to the visible configuration at a different side of the base panel;
if the base panel and the first auxiliary panel are being exposed to the host computing device as the separate displays, exposing the second auxiliary panel as another separate display; and
if the base panel and the first auxiliary panel are being exposed to the host computing device as the one display, exposing the second auxiliary panel along with the base panel and the first auxiliary panel as the one display.

4. The non-transitory computer-readable data storage medium of claim 1, wherein the auxiliary panel is a first auxiliary panel of the display device, and the processing further comprises:
detecting positioning of a second auxiliary panel of the display device from the hidden configuration behind the base panel to the visible configuration at a different side of the base panel;
if the base panel and the first auxiliary panel are being exposed to the host computing device as the separate displays, exposing the second auxiliary panel along with the base panel as the one display, the first auxiliary panel remaining exposed as a separate display; and
if the base panel and the first auxiliary panel are being exposed to the host computing device as the one display, exposing the second auxiliary panel as the separate display, the first auxiliary panel and the base panel remaining exposed as the one display.

5. The non-transitory computer-readable data storage medium of claim 1, wherein the base panel and the auxiliary panel each have a native resolution,
wherein exposing the base panel and the auxiliary panel as the separate displays comprises exposing a first display with the native resolution of the base panel, and exposing a second display with the native resolution of the auxiliary panel,
and wherein exposing the base panel and the auxiliary panel as the one display comprises exposing the one display with a native resolution spanning the native resolutions of the base and auxiliary panels.

6. A method comprising:
detecting, by a display device having a base panel and first and second auxiliary panels positioned in a hidden configuration behind the base panel, positioning of a selected auxiliary panel to a visible configuration at a side of the base panel; and
exposing, by the display device, the base panel and the selected auxiliary panel as separate displays to a host computing device to which the display device is communicatively connected or as one display to the host computing device, depending on whether the selected auxiliary panel is the first auxiliary panel or the second auxiliary panel.

7. The method of claim 6, wherein the base panel and the selected auxiliary panel are exposed as the separate displays or as the one display regardless of the side of the base panel at which the selected auxiliary display is positioned in the visible configuration.

8. The method of claim 6, wherein if the selected auxiliary panel is the first auxiliary panel, the base panel and the selected auxiliary panel are exposed as the separate displays to the host computing device,
and wherein if the selected auxiliary panel is the second auxiliary panel, the base panel and the selected panel are exposed as the one display to the host computing device.

9. The method of claim 6, wherein the selected auxiliary panel is a first selected auxiliary panel, the method further comprising:
detecting, by the display device, positioning of a second selected auxiliary panel from the hidden configuration behind the base panel to the visible configuration at a different side of the base panel;
if the base panel and the first selected auxiliary panel are being exposed to the host computing device as the separate displays, exposing the second selected auxiliary panel as another separate display; and
if the base panel and the first selected auxiliary panel are being exposed to the host computing device as the one display, exposing the second selected auxiliary panel along with the base panel and the first selected auxiliary panel as the one display.

10. The method of claim 6, wherein the selected auxiliary panel is a first selected auxiliary panel, the method further comprising:
detecting, by the display device, positioning of a second selected auxiliary panel from the hidden configuration behind the base panel to the visible configuration at a different side of the base panel;
if the base panel and the first selected auxiliary panel are being exposed to the host computing device as the separate displays, exposing the second selected auxiliary panel along with the base panel as the one display, the first selected auxiliary panel remaining exposed as a separate display; and
if the base panel and the first selected auxiliary panel are being exposed to the host computing device as the one display, exposing the second selected auxiliary panel as the separate display, the first selected auxiliary panel and the base panel remaining exposed as the one display.

11. A display device comprising:
a base panel;
a plurality of auxiliary panels individually positionable between a hidden configuration behind the base panel and a visible configuration at a side of the base panel; and
hardware logic to expose, to a host computing device to which the display device is communicatively connectable, each auxiliary panel positioned in the visible configuration as part of one display along with the base panel or as a separate display, depending on the side of the base panel at which the auxiliary panel has been positioned and/or depending on the auxiliary panel that has been positioned.

12. The display device of claim 11, wherein the hardware logic is to expose each auxiliary panel positioned in the visible configuration as the one display along with the base panel or as the separate display depending on the side of the base panel at which the auxiliary panel has been positioned.

13. The display device of claim 11, wherein the hardware logic is to expose each auxiliary panel positioned in the visible configuration as the one display along with the base panel or as the separate display depending on the auxiliary panel that has been positioned.

14. The display device of claim 11, wherein the hardware logic is to expose each auxiliary panel positioned in the visible configuration as the one display along with the base panel or as the separate display depending both on the side of the base panel at which the auxiliary panel has been positioned and on the auxiliary panel that has been positioned.

15. The display device of claim 11, wherein the base panel and the auxiliary panels each have a native resolution,
wherein for each auxiliary panel positioned in the visible configuration that the hardware logic is to expose as a separate display, the hardware logic exposes the separate display with the native resolution of the auxiliary panel,
and wherein for each auxiliary panel positioned in the visible configuration that the hardware logic is to expose as part of the one display, the hardware logic exposes the one display with a native resolution spanning the native resolution of the base panel and the native resolution of every auxiliary panel exposed as part of the one display.
